(19) United States
(12) Patent Application Publication
(10) Pub. No.: US 2026/0321817 A1
(43) Pub. Date: Oct. 15, 2026

(54) FLEXIBLE PACKAGING FOR USE IN ENERGY STORAGE DEVICES, AND METHOD OF MANUFACTURE THEREOF

(71) Applicant: Ocella, Inc., Newberry, IN (US)

(72) Inventors: Rajan Kumar, Bloomington, IN (US); Swapneel Kulkarni, Bloomingtoin, IN (US)

(21) Appl. No.: 19/104,310

(22) PCT Filed: Aug. 16, 2023
(86) PCT No.: PCT/US2023/072336

§ 371 Date: Feb. 17, 2025

Related U.S. Application Data
(60) Provisional application No. 63/371,853, filed on Aug. 18, 2022.

(51) Int. Cl. H01M 50/129; H01G 9/042; H01G 9/08; H01M 4/62; H01M 50/105; H01M 50/119; H01M 50/121; H01M 50/133; H01M 50/136

(52) U.S. Cl. CPC H01M 50/129; H01G 9/042; H01G 9/08; H01M 4/622; H01M 50/105; H01M 50/119; H01M 50/121; H01M 50/133; H01M 50/136

(57) ABSTRACT

A flexible packaging material is described, which includes an elastic material layer, a metal foil layer, and a sealant material layer. The flexible packaging material may also include at least one interlaminar adhesive layer. The flexible packaging material may be utilized to form a packaging encapsulating an energy storage device assembly, thereby forming a flexible energy storage device.

### INCORPORATION BY REFERENCE TO ANY PRIORITY APPLICATIONS

Any and all applications for which a foreign or domestic priority claim is identified in the Application Data Sheet or PCT Request as filed with the present application are hereby incorporated by reference under 37 CFR 1.57, and Rules 4.18 and 20.6. The present application claims priority to U.S. Provisional Patent Application No. 63/371,853 filed Aug. 18, 2022, the disclosure of which is incorporated herein by reference in its entirety and for all purposes.

### BACKGROUND

### Field

The present disclosure generally relates to energy storage devices, such as batteries: thermoelectric and photoelectric, and supercapacitors. More specifically, the present disclosure relates to energy storage devices (e.g., electrochemical devices) with flexible packaging.

### Description of the Related Art

Energy storage devices include batteries, fuel cells, electrochemical sensors (e.g., glucose monitors) and bio-fuel cells. Typical existing energy storage devices (e.g., batteries) may be deficient with regard to several aspects, for example with regard to charge/discharge rates, total energy, power performance, and the rigidity of the energy storage device itself.

Flexible energy storage devices require each component (e.g., separator, electrodes, packaging, and electrolyte) to be durable and flexible without compromising the integrity and performance of the device. Traditional packaging may typically be formed from multilayer materials that can be sealed to form a pouch that will contain the other components of the energy storage device (e.g., separator, electrodes, and electrolyte). However, typical packaging does not meet emerging requirements for flexible energy storage devices. Therefore, there is a need for improved packaging for flexible energy storage devices.

### SUMMARY

For purposes of summarizing the disclosure and the advantages achieved over the prior art, certain objects and advantages of the disclosure are described herein. Not all such objects or advantages may be achieved in any particular embodiment. Thus, for example, those skilled in the art will recognize that the invention may be embodied or carried out in a manner that achieves or optimizes one advantage or group of advantages as taught herein without necessarily achieving other objects or advantages as may be taught or suggested herein.

In one aspect, a flexible packaging material is described. The flexible packaging material includes an elastic material layer; a metal foil layer; and a sealant material layer.

In one aspect, a flexible packaging material is described. The flexible packaging material includes an elastic material layer; a metal foil layer; and a sealant material layer; wherein the metal foil layer is disposed between the elastic material layer and the sealant material layer.

In some embodiments, the elastic material layer comprises a material selected from the group consisting of a thermoplastic material, a thermoset material, and combinations thereof. In some embodiments, the elastic material layer comprises a polymer selected from the group consisting of a styrene polymer, an isoprene polymer, an ethylene polymer, a propylene polymer, a butadiene polymer, a butylene polymer, a diene polymer, a polyurethane polymer, an acetate polymer, copolymers thereof, and mixtures thereof. In some embodiments, the elastic material layer comprises a thickness of about 50-100 μm.

In some embodiments, the metal foil layer comprises Al. In some embodiments, the metal foil layer comprises a thickness of about 20-60 μm. In some embodiments, the sealant material layer comprises a material selected from the group consisting of nylon (ONY), a polypropylene (PP) resin, an ethylene and acrylic acid (EAA) a copolymer resin, copolymers thereof, orientations thereof, and mixtures thereof. In some embodiments, the sealant material layer comprises a thickness of about 30-100 μm.

In some embodiments, the flexible packaging material further comprises at least one interlaminar adhesive layer. In some embodiments, a position of the at least one interlaminar adhesive layer is selected from the group consisting of disposed between the elastic material layer and the metal foil layer, disposed between the metal foil layer and the sealant material layer, and combinations thereof. In some embodiments, the at least one interlaminar adhesive layer comprises a material selected from the group consisting of a urethane adhesive, an acrylic adhesive, a polyolefin adhesive, and combinations thereof. In some embodiments, the at least one interlaminar adhesive layer comprises a thickness of about 5-15 μm.

In another aspect, a flexible energy storage device is described. The flexible energy storage device includes a flexible packaging material; a cathode; an anode; and a separator disposed between the another and the cathode.

In some embodiments, the flexible energy storage device further comprises an electrolyte. In some embodiments, wherein at least one of the cathode and the anode comprises an electron beam cured polymer binder.

In another aspect, a method of forming a flexible energy storage device is described. The method includes disposing an energy storage device assembly between a top packaging material and a bottom packaging material, wherein the top and bottom packaging materials each comprise a flexible packaging material; sealing the top and bottom packaging materials to form a sealed packaging, wherein the energy storage device assembly and the sealed packaging form the flexible energy storage device.

In some embodiments, sealing comprises a sealing temperature of about 130-210° C. In some embodiments, sealing comprises a sealing pressure of about 25-60 psi. In some embodiments, sealing comprises a sealing time of about 2-10 second.

In another aspect, a method of forming a flexible packaging material is described. The method includes disposing a metal foil layer over an elastic material layer; and disposing a sealant material layer over the metal foil layer.

In some embodiments, the method further comprises disposing a first interlaminar adhesive layer over the elastic material layer, and disposing the metal foil layer over the first interlaminar adhesive layer. In some embodiments, the method further comprises disposing a second interlaminar adhesive layer over the metal foil layer, and disposing the sealant material layer over the second interlaminar adhesive layer.

All of these embodiments are intended to be within the scope of the invention herein disclosed. These and other embodiments will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 is an illustration of a cathode, separator and anode assembly, according to some embodiments.

FIG. 2 is an illustration of an energy storage device, according to some embodiments.

FIG. 3A is an illustration of a flexible packaging material, according to some embodiments.

FIG. 3B is an illustration of a flexible packaging material with interlaminar adhesive layers, according to some embodiments.

FIG. 4 is an illustration of a flexible packaging material, according to some embodiments.

FIG. 5A is an illustration of a process of preparing a flexible packaging material, according to some embodiments.

FIG. 5B is an illustration of a process of preparing a flexible packaging material with interlaminar adhesive layers, according to some embodiments.

FIG. 6 is an illustration of a process of preparing a flexible packaging material, according to some embodiments.

FIG. 7 is an illustration of a process of sealing a cathode, separator and anode assembly within a flexible packaging, according to some embodiments.

FIG. 8A is an illustration of a control packaging material used to form a packaging of an energy storage device.

FIG. 8B is an illustration of a flexible packaging material used to form a packaging of a flexible energy storage device, according to some embodiments.

FIG. 8C is an illustration of a flexible packaging material used to form a packaging of a flexible energy storage device, according to some embodiments.

FIG. 9 shows a voltage v. time graph depicting the charge/discharge results of a control energy storage device and a flexible energy storage device, according to some embodiments.

### DETAILED DESCRIPTION

Although certain embodiments and examples are described below, those of skill in the art will appreciate that the invention extends beyond the specifically disclosed embodiments and/or uses and obvious modifications and equivalents thereof. Thus, it is intended that the scope of the invention herein disclosed should not be limited by any particular embodiments described below.

In this disclosure, an improved flexible packaging material for energy storage device packaging is disclosed. In some embodiments, the flexible packaging material comprises multiple layers of materials. For example, in certain embodiments, the multiple layers include an elastic material layer used as a base material, a metal foil layer and a sealant material layer, to build a robust, impermeable dielectric film for the energy storage device (e.g., battery) packaging. In some embodiments, the use of an elastic material layer allows for the formation of a flexible packaging with improved flexibility, durability, conformability, and/or stretchability, while simultaneously sealing the other components of the energy storage device (e.g., separator, electrodes, and electrolyte) within the packaging. In some embodiments, the flexible packaging formed from the flexible packaging material is or is substantially impermeable water and air, and resistant to degradation due to the operation of the energy storage device itself and/or electrolyte contained within.

In some embodiments, the energy storage (e.g., electrochemical) device may include a battery. In some embodiments, the energy storage (e.g., electrochemical) device may include fuel cells, electrochemical sensors (glucose monitors), bio-fuel cells, and combinations thereof. In some embodiments, the disclosed energy storage device (e.g., battery) may be a solid-state energy storage device.

### Energy Storage Device

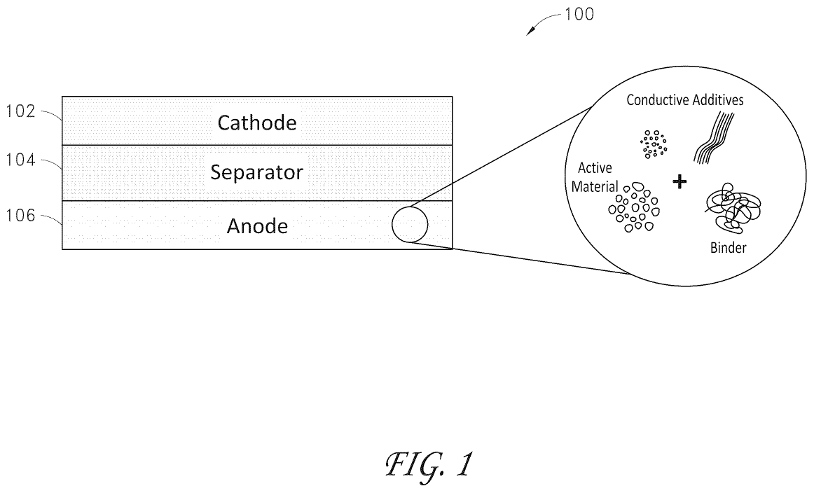

FIG. 1 illustrates an assembly 100 comprising a cathode 102, a separator 104, and an anode 106. The electrodes (i.e., cathode 102 and anode 106) each comprise an electrode film disposed over a current collector. The electrode films comprise an active material and a binder, and may further comprise additional elements such as a conductive additive. As depicted in FIG. 1, the electrode film of the anode 106 includes active material particles, a binder, and conductive additive particles and/or nanostructures in certain embodiments.

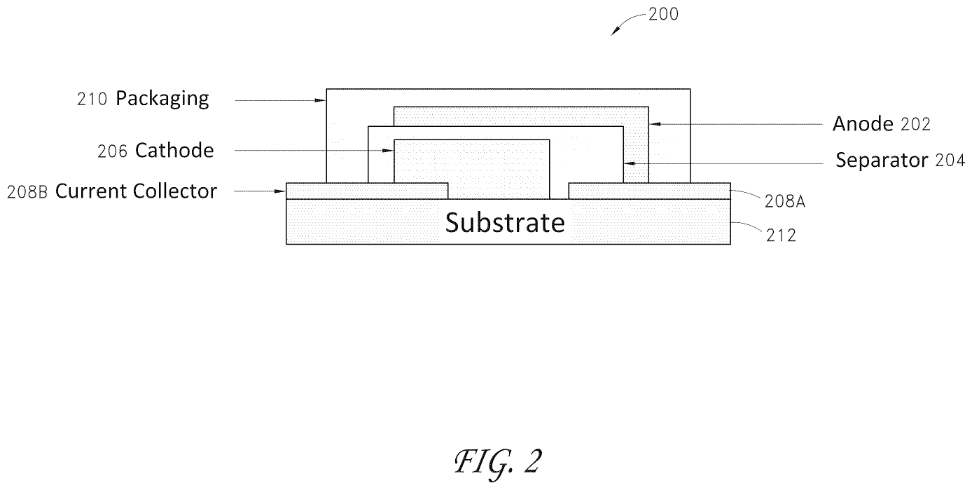

FIG. 2 is an illustration of an assembled die cut shaped energy storage device 200. The energy storage device 200 includes an anode 202 and a cathode 206 separated by a separator 204, which is encased in a packaging 210. The anode 202 is in electrical contact with a current collector 208A, and the cathode 206 is in electrical contact with a current collector 208B. In the illustrated embodiment, the components of the energy storage device 200 are shown disposed over a substrate 212. In some embodiments, the energy storage device 200 further includes anode and cathode electrical connectors (e.g., leads and/or tabs) from the anode and cathode current collectors 208A, 208B, respectively, coming out of the sealed film and/or are exposed in order for the energy storage device 200 to make electrical connections with a device in need thereof. In some embodiments, the substrate 212 also comprises a material the same, substantially the same or similar to the material of the packaging 210, such that the packaging 210 and substrate 212 form a seal and encapsulate the anode 202, cathode 206 and separator 204 to form a water-impermeable and/or oxygen-impermeable packaging. For example, in some embodiments the packaging 210 and substrate 212 each are or comprise a flexible packaging material described herein.

The energy storage device 200 can be a primary or rechargeable energy storage device, and in various forms. Prior to assembly and sealing the cell of the energy storage device 200, the device 200 may be filled with an electrolyte. In some embodiments, the energy storage device 200 is a battery, a capacitor, or a combination thereof. In some embodiments, the energy storage device 200 is a solid state energy storage device such that the energy storage device 200 includes a solid state electrolyte positioned between the cathode 206 and the anode 202. In some embodiments, the solid state electrolyte is in a semisolid (e.g., gel) or solid form.

The energy storage device 200 can include a first electrode 202, 206 that includes a first current collector 208A, 208B in contact with a first electrode film (e.g., a cathode electrode with a cathode electrode film), and a second electrode 202, 206 that includes a second current collector 208A, 208B in contact with a second electrode film (e.g., an anode electrode with an anode electrode film). The first current collector 208A, 208B and the second current collector 208A, 208B may facilitate electrical coupling between each corresponding electrode film and an external circuit (not shown). For example, the current collector 208A, 208B (i.e., base layer) can include a metallic material, such as a material comprising aluminum, nickel, copper, rhenium, niobium, tantalum, and noble metals such as silver, gold, platinum, palladium, rhodium, osmium, iridium and alloys and combinations of the foregoing. For example, the current collector 208A, 208B can comprise a metal foil, for example, a nickel foil, an aluminum foil, a carbon foil, a copper foil, a carbon coated metal foil, or a tantalum coated metal foil. In some embodiments, the current collector 208A, 208B (i.e., base layer) may include copper, aluminum, and coated metal foils, and combinations thereof. The electrode 202, 206 can include at least one electrode film on or disposed over a surface of the current collector 208A, 208B. In some embodiments, the electrode 202, 206 may be a multilayer electrode and comprise more than one electrode film, for example, such as a first electrode film and a second electrode film disposed on the same or different sides of the current collector 208A, 208B. In some embodiments, the multilayered electrode is heterogeneous such that the properties, loading, thickness and/or composition of a first electrode film is different than that of a second electrode film of the electrode.

The electrode film may comprise a cathode active material or an anode active material. In some embodiments, the electrode film and/or electrode film mixture comprises the active material in, in about, in at least, or in at least about, 60 wt. %, 65 wt. %, 70 wt. %, 75 wt. %, 80 wt. %, 85 wt. %, 90 wt. %, 92 wt. %, 95 wt %, 97 wt. %, 98 wt. % or 99 wt. %, or any range of values therebetween.

The cathode active material can include, for example, carbon monofluoride (CFx), metal oxide, metal sulfide, or a lithium metal oxide. The lithium metal oxide can be, for example, a lithium nickel manganese cobalt oxide (NMC), a lithium manganese oxide (LMO), a lithium iron phosphate (LFP), a lithium cobalt oxide (LCO), a lithium titanate (LTO), and/or a lithium nickel cobalt aluminum oxide (NCA). In some embodiments, cathode active materials can comprise, for example, a layered transition metal oxide (such as LiCoO₂ (LCO), Li(NiMnCo)O₂ (NMC) and/or LiNi_{0.8}Co_{0.15}Al_{0.05}O₂ (NCA)), a spinel manganese oxide (such as LiMn₂O₄ (LMO) and/or LiMn_{1.5}Ni_{0.5}O₄ (LMNO)), an olivine (such as LiFePO₄), chalcogenides (LiTiS₂), tavorite (LiFeSO₄F), silicon, silicon oxide (SiOx), aluminum, tin, tin oxide (SnOx), manganese oxide (MnOx), molybdenum oxide (MoO₂), molybdenum disulfide (MoS₂), nickel oxide (NiOx), or copper oxide (CuOx). The anode active materials can include, for example, an insertion material (such as carbon, graphite (natural, synthetic or blends), hard or amorphous carbons and/or graphene), an alloying/dealloying material (such as silicon, silicon oxide, tin, and/or tin oxide), a metallic element, metal alloy or compound (such as Si—Al, and/or Si—Sn), and/or a conversion material (such as manganese oxide, molybdenum oxide, nickel oxide, and/or copper oxide). The anode active materials can be used alone or mixed together to form multi-phase materials (such as Si—C, Sn—C, SiOx-C, SnOx-C, Si—Sn, Si-SiOx, Sn-SnOx, Si-SiOx-C, Sn-SnOx-C, Si—Sn—C, SiOx-SnOx-C, Si-SiOx-Sn, or Sn-SiOx-SnOx.).

In some embodiments, the electrode film and/or electrode film mixture can comprise a binder. In some embodiments, the electrode film comprises the binder in, in about, in at most, in at most about, 0.5 wt. %, 1 wt. %, 2 wt. %, 3 wt. %, 4 wt. %, 5 wt. %, 6 wt. %, 7 wt. %, 8 wt. %, 9 wt. %, 10 wt. %, 15 wt. %, 20 wt. % or 25 wt. %, or any range of values therebetween. In some embodiments, the binder is a polymerizable binder. In some embodiments, the polymerizable binder is electron beam (“e-beam” or “EB”) polymerizable and/or curable. Binders may include an acrylated polyurethane resin (e.g. Ucecoat 7689, Ucecoat 7510, and Ucecoat 7690 (i.e. a polyurethane acrylate, acrylate ester and/or acrylated monomer dispersion in water)), a hydroxy modified acrylated polyurethane resin (e.g., hydroxy modified Ucecoat 7690), an acrylate-methacrylate monomer blend (e.g. Ebecryl 109), a monoacrylate of mono-ethoxylated phenol (e.g. Ebecryl 114), trimethylolpropane ethoxy triacrylate (TMPEOTA), an acrylonitrile and/or acrylamide (e.g., LA133), polytetrafluoroethylene (PTFE), a polyolefin, polyalkylenes, polyethers, styrene-butadiene, co-polymers of polysiloxanes, a polysiloxane, branched polyethers, polyvinylethers, polyacrylic acid (PAA), styrene-butadiene rubber (SBR), co-polymers thereof, and/or admixtures thereof. The binder can include a cellulose, for example, carboxymethylcellulose (CMC). In some embodiments, the polyolefin can include polyethylene (PE), polypropylene (PP), polyvinylidene fluoride (PVDF), co-polymers thereof, and/or mixtures thereof. For example, the binder can include polyvinylene chloride, poly(phenylene oxide) (PPO), polyethylene-block-poly(ethylene glycol), poly(ethylene oxide) (PEO), poly(phenylene oxide) (PPO), polyethylene-block-poly(ethylene glycol), polydimethylsiloxane (PDMS), polydimethylsiloxane-coalkylmethylsiloxane, co-polymers thereof, and/or admixtures thereof. In some embodiments, the binder may include an acrylated polyurethane resin, an acrylate-methacrylate monomer blend, a monoacrylate of mono-ethoxylated phenol, polyvinylidene fluoride (PVDF), and combinations thereof. In some embodiments, the binder may include an acrylated polyurethane resin, an acrylate-methacrylate monomer blend, a monoacrylate of mono-ethoxylated phenol, and combinations thereof.

In some embodiments, the electrode film and/or electrode film mixture can comprise an additive. In some embodiments, the electrode film and/or electrode film mixture comprises the additive in, in about, in at most, in at most about, 0.05 wt. %, 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt. %, 1.5 wt. %, 2 wt. %, 3 wt. %, 4 wt. %, 5 wt. %, 6 wt. %, 7 wt. %, 8 wt. %, 9 wt. %, 10 wt. %, 15 wt. %, 20 wt. % or 25 wt. %, or any range of values therebetween. In some embodiments, the additive is a conductive additive, a rheological additive, an etching additive, or combinations thereof. In some embodiments, the additive is a conductive additive. In some embodiments, conductive additives may be selected from carbon black, carbon nano-particles, a graphitic material, graphite, graphene-containing materials, hard carbon, soft carbon, carbon nanotubes, carbon nanofibers, porous carbon, conductive carbon, a high-aspect ratio conductive additive or a combination thereof. In some embodiments, the graphitic material can be a surface treated material. In some embodiments, the porous carbon can comprise activated carbon. In some embodiments, the porous carbon can comprise hierarchically structured carbon. In some embodiments, the porous carbon can include structured carbon nanotubes, structured carbon nanowires and/or structured carbon nanosheets. In some embodiments, the porous carbon can include graphene sheets. In some embodiments, the porous carbon can be a surface treated carbon. In some embodiments, the high-aspect ratio conductive additive is selected from a carbon nanofiber, a carbon nanotube, a chopped carbon nanofiber, a nanowire, a chopped metal thread, and combinations thereof. In some embodiments, the chopped metal thread comprises a metal nickel, copper, silver, and combinations thereof. The high aspect ratio fibers allow the battery electrodes to maintain electrical contact during the deformation. In some embodiments, the additive is a rheological additive. In some embodiments, a rheological additive includes oxalic acid. In some embodiments, the additive is an etching additive. In some embodiments, the etching additive is added to the electrode film mixture and/or to the current collector to remove or reduce the oxidation layer of a current collector once applied, thereby allowing the electrode film to strongly adhere to the current collector (e.g., resulting in improved electrical conductivity and battery performance). In some embodiments, an etching additive includes oxalic acid, nitric acid, HCl, or combinations thereof.

In some embodiments, the electrode film may comprise a surfactant. In some embodiments, the surfactant is selected from a hydrocarbon surfactant, a fluoro surfactant, a silicon surfactant, a polyoxypropylene surfactant, and combinations thereof. In some embodiments, the surfactant is selected from an amphiphilic surfactant, a cationic surfactant, an anionic surfactant, a non-ionic surfactant, a polymeric surfactant, a biosurfactant, and combinations thereof. In some embodiments surfactants include polyethylene glycol derivatives (e.g., Triton X-100

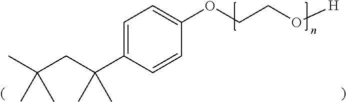

(molecular weight 695 g/mol to 1,000.000 g/mol)), polyvinylpyrrolidone (PVP), cationic poly(ethyleneimine) (PEI, molecular weight 10,000 g/mol to 1,000.000 g/mol), and anionic poly(acrylic acid) (PAA, molecular weight 15,000 g/mol to 1,000.000 g/mol). In some embodiments, surfactant provides properties such as reduced surface tension and energy, emulsification, dispersion and solubilization for casting and/or drying of the electrode film. In some embodiments, surfactants include structure-directing agents, carbon sources, porogen agents and stabilizer agents. In some embodiments, the surfactant includes a molecular weight of, of about, of at most, or of at most about, 300 g/mol, 500 g/mol, 600 g/mol, 700 g/mol, 800 g/mol, 1,000 g/mol, 2,000 g/mol, 5,000 g/mol, 10,000 g/mol, 15,000 g/mol, 20,000 g/mol, 30,000 g/mol, 40,000 g/mol, 50,000 g/mol, 60,000 g/mol or 80,000 g/mol, or any range of values therebetween. In some embodiments the electrode film and/or electrode film mixture comprises the surfactant in, in about, in at most, in at most about, 0.001 wt. %, 0.005 wt. %, 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt. %, 2 wt. %, 3 wt. %, 4 wt. %, 5 wt. %, 6 wt. %, 7 wt. %, 8 wt. %, 9 wt. % or 10 wt. %, or any range of values therebetween.

The energy storage device 200 can include any number of different types of electrolyte. For example, in some embodiments, the device 200 can include a lithium ion battery electrolyte, which can include a lithium source, such as a lithium salt, and a solvent, such as an organic solvent. In some embodiments, the device can further include an electrolyte additive, such as solid electrolyte interphase (SEI)-forming additive, an electrode wetting additive, or a separator wetting additive. In some embodiments, a lithium salt can include lithium hexafluorophosphate (LiPF₆), lithium tetrafluoroborate (LiBF₄), lithium perchlorate (LiClO₄), lithium bis(trifluoromethansulfonyl)imide (LiN(SO₂CF₃)₂), lithium trifluoromethansulfonate (LiSO₃CF₃), lithium bis(pentafluoroethanesulfonyl)imide (C₄F₁₀LiNO₄S₂), lithium bis(fluorosulfonyl)imide (F₂LiNO₄S₂), lithium bis(oxalato)borate (LiB(C₂O₄)₂), lithium difluoro(oxalato) borate (LiBF₂(C₂O₄), lithium difluorophosphate (F₂LiO₂P), lithium oxalyldifluoroborate, lithium trifluorochloroborate (LiBF₃Cl), lithium hexafluoroarsenate (LiAsF₆), lithium bis(trifluoromethanesulfonyl)imide (LiTFSi), combinations thereof, and/or the like. In some embodiments, a lithium ion electrolyte solvent can include one or more ethers and/or esters. For example, a lithium ion electrolyte solvent may comprise ethylene carbonate (EC), dimethyl carbonate (DMC), diethyl carbonate (DEC), ethyl methyl carbonate (EMC), vinyl carbonate (VC), propylene carbonate (PC), fluoroethylene carbonate (FEC), 1,3-propane sultone (PS), combinations thereof, and/or the like. For example, the electrolyte may comprise LiPF₆, ethylene carbonate, propylene carbonate and diethyl carbonate. In some embodiments, the device can include a solid state electrolyte. In some embodiments, the solid state electrolyte also functions as a separator.

Electrodes described herein may be prepared by various processes. As one example, in some embodiments an electrode film mixture (e.g. comprising the active material, binder, and optionally additives) are combined with a solvent to form an electrode film slurry. In some embodiments, the solvent is an aqueous solvent, an organic solvent, or a combination thereof. As another example, in some embodiments an electrode film mixture (e.g. comprising the active material, binder, and optionally additives) is combined and an electrode film is formed in a solvent-free dry electrode manufacturing process. In some embodiments, the electrode film mixture further comprises a surfactant and/or an additive (e.g. a conductive additive, a rheological additive, and/or an etching agent). In some embodiments, the solvent includes water, N-methylpyrrolidone (NMP), other organic solvents, or combinations thereof. The electrode film slurry may then be cast upon a substrate to form an as-cast electrode film. In some embodiments, casting of the electrode film slurry may be performed using a doctor blade, spray coating, comma bar, slot die, aerosol, gravure, screen printing, imprinting, spin-coating, electrospinning, ultrasonic spray, electrostatic spray, and combinations thereof. The as-cast electrode film may then be dried and/or cured to form an electrode film. In some embodiments, the as-cast electrode film or electrode film is calendered (e.g. a roll-to-roll process). In some embodiments, the as-cast electrode film or electrode film is not calendered. In solvent-free dry electrode manufacturing processes the electrode film may be formed using dry materials, such as a calendering process. In some embodiments, the substrate which the dry electrode film or electrode film slurry is cast upon is a current collector, and as such an electrode is formed once the electrode film is deposited, dried and/or cured.

Drying may be performed by heating (e.g., vacuum heating and/or convection heating) the as-cast electrode film to evaporate the solvent. Curing may be performed to polymerize the binder to form a binder matrix within the electrode film. In some embodiments, curing is performed by an energy source, such as for example photons and/or electrons. In some embodiments, curing is performed by an electron beam (“e-beam” or “EB”). In some embodiments, the curing is performed with an EB with, with about, with at least, or with at least about, 50 kV, 100 kV, 150 kV, 200 kV, 250 kV 300 kV, or any range of values therebetween. In some embodiments, the curing is performed with an EB with, with about, with at least, or with at least about, 15 kGy, 20 kGy, 25 kGy, 30 kGy, 40 kGy, 50 kGy, 60 kGy, 70 kGy, 80 kGy or 100 kGy, or any range of values therebetween.

### Flexible Packaging Material

In some embodiments, the flexible packaging material comprises an elastic material layer, a metal foil layer and a sealant material layer. In some embodiments, the elastic material layer comprises an elastic polymer. In some embodiments, the elastic material layer comprises a thermoplastic material, a thermoset material, or combinations thereof. In some embodiments, the elastic polymer comprises a thermoplastic polymer, a thermoset polymer, or combinations thereof. In some embodiments, the elastic polymer comprises a styrene polymer, an isoprene polymer, an ethylene polymer, a propylene polymer, a butadiene polymer, a butylene polymer, a diene polymer, a polyurethane polymer, an acetate polymer (e.g., vinyl acetate), copolymers thereof (e.g., block copolymers, for example such as A-B or A-B-A block copolymers), and mixtures thereof. For example, the elastic material layer may comprise or consist of a thermoset material (e.g., Panasonic Beyolex™). In some embodiments, the elastic material layer is, is about, is at least, or is at least about, 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm or 200 μm, or any range of values therebetween. In some embodiments, the flexible packaging material comprises, or comprises at least, 1, 2, 3, 4 or 5 layers, or any range of values therebetween, of the elastic material layer.

In some embodiments, the metal foil layer is impermeable or substantially impermeable to oxygen and/or water. In some embodiments, the metal foil layer comprises aluminum. In some embodiments, the metal foil layer comprises an aluminum (“Al”) foil or coating. In some embodiments, the metal foil layer is coated on and/or disposed over the elastic material layer. In some embodiments, the metal foil layer comprises at least one surface that is surface treated. In some embodiments, the metal foil layer is, is about, is at least, or is at least about, 5 μm, 10 μm, 15 μm, 20 μm, 25 μm, 30 μm, 35 μm, 40 μm, 45 μm, 50 μm, 60 μm, 70 μm, 80 μm, 90 μm or 100 μm, or any range of values therebetween. In some embodiments, the flexible packaging material comprises, or comprises at least, 1, 2, 3, 4 or 5 layers, or any range of values therebetween, of the metal foil layer.

In some embodiments, the sealant material layer may be used to seal the flexible packaging material to form a packaging, for example by sealing together the sealant materials layers from two or more flexible packaging materials. In some embodiments, the sealant material layer is impermeable or substantially impermeable to oxygen and/or water. In some embodiments, the sealant material layer comprises a sealant material. In some embodiments, the sealant material comprises a thermal adhesive. In some embodiments, the sealant material comprises nylon (“ONY”), a polypropylene (PP) resin (e.g., cast polypropylene (CPP), blown polypropylene (BPP) and other variants), an ethylene and acrylic acid (EAA) copolymer resin, copolymers thereof, orientations thereof (e.g., bi-axially oriented), and/or mixtures thereof. In some embodiments, the sealant material is, is about, is at least, or is at least about, 3 μm, 5 μm, 10 μm, 15 μm, 20 μm, 25 μm, 30 μm, 35 μm, 40 μm, 45 μm, 50 μm, 60 μm, 70 μm, 80 μm, 90 μm, 100 μm, 110 μm, 120 μm, 130 μm, 140 μm, 150 μm or 200 μm, or any range of values therebetween. In some embodiments, the flexible packaging material comprises, or comprises at least, 1, 2, 3, 4 or 5 layers, or any range of values therebetween, of the sealant material layer.

In some embodiments, the flexible packaging material may comprise at least one intermediate or interlaminar layer. In some embodiments, the intermediate or interlaminar layer may comprise a material selected from polyethylene terephthalate (“PET”), an adhesive (e.g., a pressure sensitive adhesive (“PSA”)), a polypropylene (e.g., a polypropylene (“PP”) film), and combinations thereof. In some embodiments, the PSA is selected from a urethane adhesive (e.g., Loctite Liofol LA 3649 adhesive and LA 6255 curing agent), an acrylic adhesive, a polyolefin adhesive, and combinations thereof. In some embodiments, the intermediate or interlaminar layer is, is about, is at least, or is at least about, 1 μm, 2 μm, 3 μm, 4 μm, 5 μm, 6 μm, 7 μm, 8 μm, 9 μm, 10 μm, 15 μm, 20 μm, 25 μm, 30 μm, 35 μm, 40 μm, 45 μm, 50 μm, 60 μm, 70 μm, 80 μm, 90 μm or 100 μm, or any range of values therebetween. In some embodiments, the flexible packaging material comprises, or comprises at least, 1, 2, 3, 4, 5, 6, 7, 8, 9 or 10 layers, or any range of values therebetween, of the intermediate or interlaminar layer.

In some embodiments, one or more layers of the flexible packaging material (e.g., elastic material layer, metal foil layer, sealant material layer, intermediate layer) may be treated. In some embodiments, the treatment is a chemical treatment, surface treatment, or combinations thereof. In some embodiments, the treatment may include a corona treatment. In some embodiments, the treatment may improve adhesion between surfaces of adjacent layers.

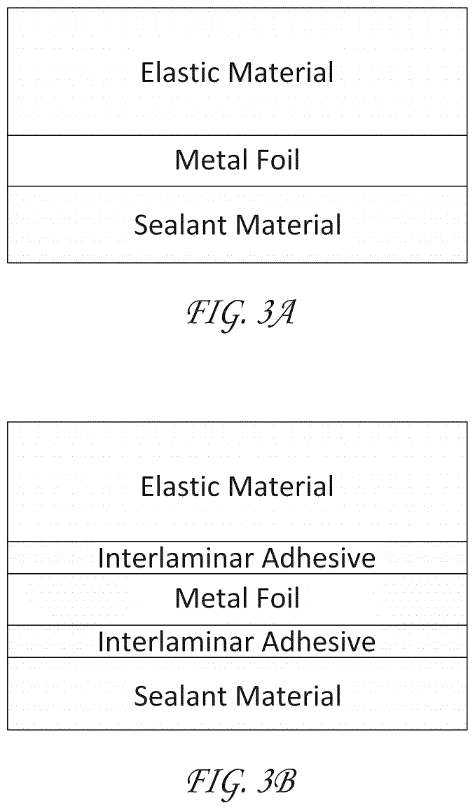

FIG. 3A is an illustration of a flexible packaging material, wherein the flexible packaging material comprises an elastic material layer, a metal foil layer disposed over the elastic material layer, and a sealant material layer disposed over the metal foil layer. FIG. 3B is an illustration of a flexible packaging material with interlaminar adhesive layers, wherein the flexible packaging material comprises an elastic material layer, a first interlaminar adhesive layer disposed over the elastic material layer, a metal foil layer disposed over the first interlaminar adhesive layer, a second interlaminar adhesive layer disposed over the metal foil layer, and a sealant material layer disposed over the second interlaminar adhesive layer.

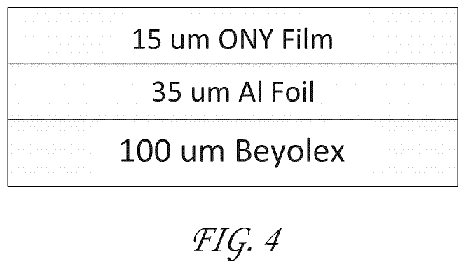

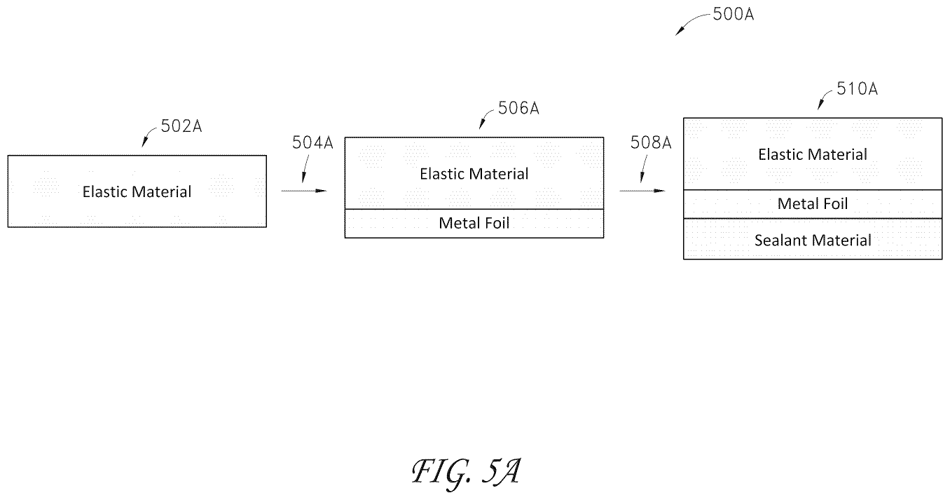

FIG. 4 is an illustration of an example flexible packaging material. In certain embodiments, the flexible packaging material comprises an elastic material layer, an Al metal foil layer disposed over the elastic material layer, and a biaxially oriented nylon-6,6 sealant material layer disposed over the metal foil layer. For example, in the illustrated embodiment, the flexible packaging material comprises 100 μm of a Beyolex™ elastic material layer, 35 μm of an Al metal foil layer disposed over the elastic material layer, and 15 μm of a biaxially oriented nylon-6,6 sealant material layer disposed over the metal foil layer. Of course, the listed thicknesses are only exemplary and can instead have other values. Although not depicted in FIG. 4, intermediate layers comprising PSA can be disposed between the individual layers of the flexible packaging material.

### Method of Fabricating Flexible Packaging Material

The flexible packaging material may be fabricated by disposing each layer of material over another. In some embodiments, the flexible packaging material includes an interlaminar adhesive layer. In some embodiments, the interlaminar adhesive layer is disposed between adjacent layers of the flexible packaging. For example, in certain embodiments, the interlaminar adhesive layer binds the adjacent layers of the flexible packaging together.

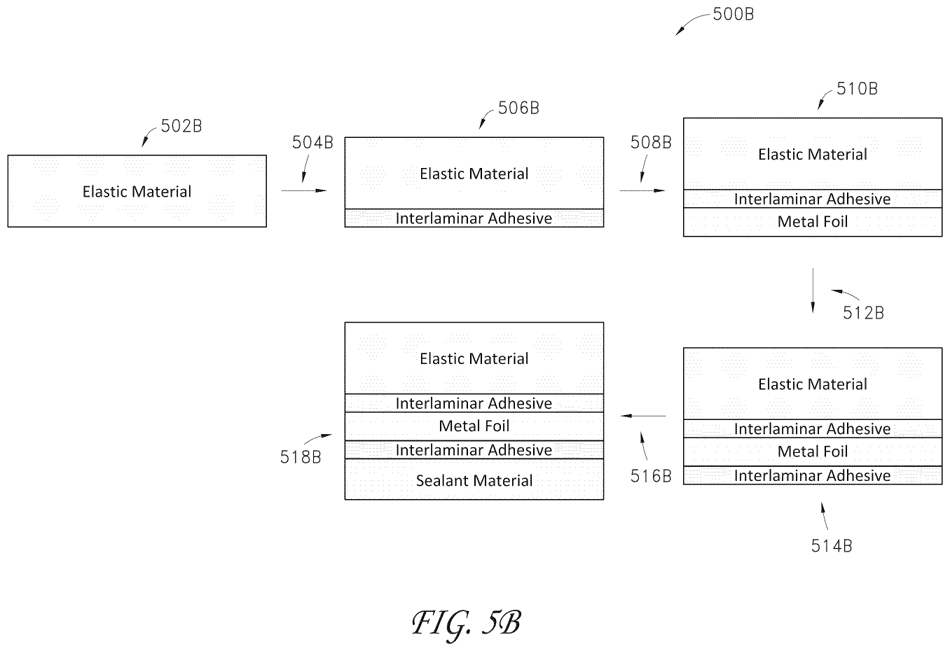

FIG. 5A is an illustration of a process 500A of preparing a flexible packaging material. The process 500A begins with an elastic material layer 502A, and in step 504A a metal foil is disposed on the elastic material layer 502A to form a first intermediate assembly 506A. In step 508A, a sealant material layer is disposed on the metal foil of the first intermediate assembly 506A to form the flexible packaging material 510A.

FIG. 5B is an illustration of a process 500B of preparing a flexible packaging material with interlaminar adhesive layers. The process 500B begins with an elastic material layer 502B, and in step 504B a first interlaminar adhesive layer is disposed on the elastic material layer 502B to form a first intermediate assembly 506B. In step 508B, a metal foil is disposed on the first interlaminar adhesive layer of the first intermediate assembly 506B to form a second intermediate assembly 510B. In step 512B, a second interlaminar adhesive layer is disposed on the metal foil of the second intermediate assembly 510B to form a third intermediate assembly 514B. In step 516B, a sealant material is disposed on the second interlaminar adhesive layer of the third intermediate assembly 514B to form the flexible packaging material 518B.

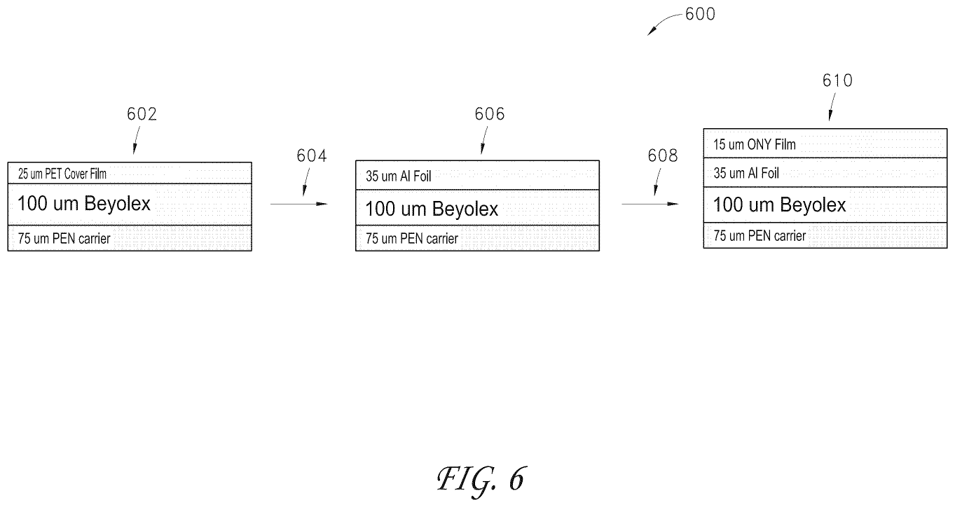

FIG. 6 is an illustration of an example process 600 for preparing a flexible packaging material, where an initial assembly 602 comprises 75 μm of a polyethylene naphthalate (PEN) carrier film, 100 μm of a Beyolex™ elastic material layer disposed over the carrier film, and 25 μm of a PET cover film disposed over the elastic material. In step 604, the cover film is removed from initial assembly 602 and 35 μm of an Al metal foil layer is disposed over the elastic material layer to form a first intermediate assembly 606. In step 608, 15 μm of a nylon (“ONY”) sealant material layer is disposed over the metal foil layer to form a second intermediate assembly 610. From the second intermediate assembly 610 the carrier film may be removed to form a flexible packaging material, for example the flexible packaging material depicted in FIG. 4.

In some embodiments, additional elastic polymer layers, additional metal foil layers, additional sealant material layers, and/or intermediate layers may be disposed under, over and/or between the layers during the fabrication of the flexible packaging material. For example, in some embodiments, in FIG. 6 prior to disposing 35 μm of an Al metal foil layer over the elastic material layer a PSA may be disposed over the elastic material. As a further example, in some embodiments, in FIG. 6 prior to disposing 15 μm of a nylon (“ONY”) sealant material layer over the 35 μm of an Al metal foil layer a PSA may be disposed over the 15 μm of a nylon (“ONY”) sealant material layer.

### Method of Using Flexible Packaging Material

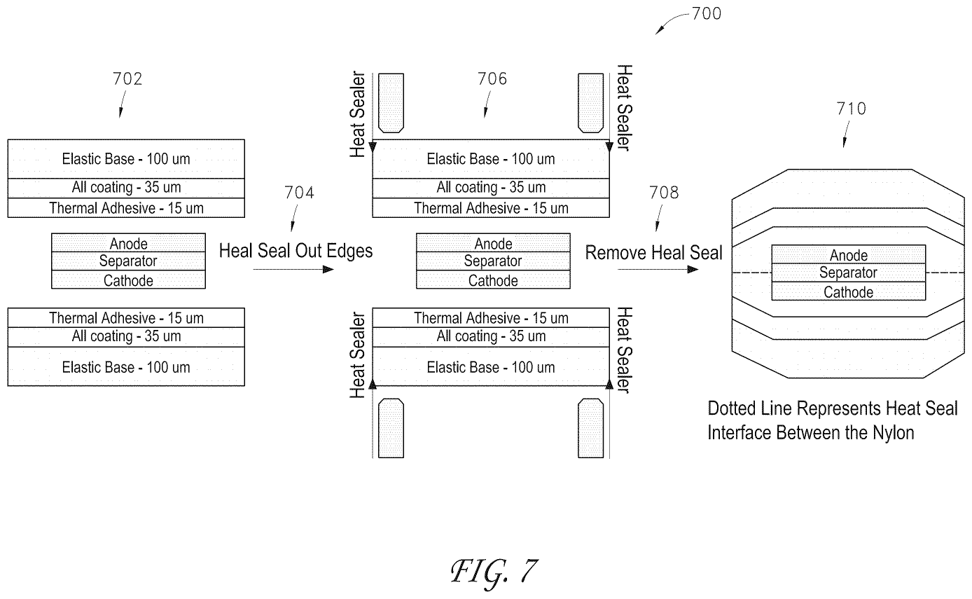

The flexible packaging material may be used to form a flexible packaging encapsulating components of the energy storage device (e.g., separator, electrodes, and electrolyte), thereby forming an energy storage device. In some embodiments, 1, 2, 3, 4 or 5 flexible packaging materials, or any range of values therebetween, may be used to form a flexible packaging. FIG. 7 is an illustration of a process 700 of sealing a cathode, separator and anode assembly within a flexible packaging. A first assembly 702 comprising a first flexible packaging material disposed over an anode, separator and cathode assembly, and a second flexible packaging material are provided. The first and second flexible packaging materials each comprise an elastic material layer (“Elastic Base—100 μm”) disposed over an Al metal foil layer (“Al coating—35 μm”) disposed over a thermal adhesive sealant material layer (“Thermal Adhesive—15 μm”), wherein the sealant material layers of the first and second flexible packaging materials are adjacent to the anode, separator and cathode assembly. In step 704, heat sealers are provided to the ends of the flexible packaging materials over the elastic material layers to form a second assembly 706, and in step 708 the thermal adhesive sealant material layers of the first and second flexible packaging materials heat sealed together thereby forming a packaging that thereby forms an energy storage device 710. In some embodiments, the sides of the packaging material are treated (e.g., corona treated) to improve adhesion and/or the sealing properties of the packaging. In some embodiments, an electrolyte is introduced to the anode, separator and cathode assembly prior to and/or subsequent to sealing step 708, and therefore the electrolyte is also encapsulated by the packaging.

The sealing parameters used to seal the flexible packaging material to form the flexible packaging may be useful in forming a suitable seal and/or prevent damage to the flexible packing material or the components of the energy storage device. In some embodiments, the temperature utilized during sealing is, is about, is at most, or is at most about 80° C., 100° C., 110° C., 120° C., 130° C., 140° C., 150° C., 160° C., 170° C., 180° C., 190° C., 200° C., 210° C., 220° C., 230° C., 240° C., 250° C. or 260° C., or any range of values therebetween. In some embodiments, the pressure utilized during sealing is, is about, is at most, or is at most about, 10 psi, 20 psi, 25 psi, 30 psi, 35 psi, 40 psi, 45 psi, 50 psi, 55 psi, 60 psi, 70 psi, 80 psi, 90 psi or 100 psi, or any range of values therebetween. In some embodiments, the sealing is performed for, for about, for at most, or for at most about, 0.5 seconds, 1 second, 2 seconds, 3 seconds, 4 seconds, 5 seconds, 6 seconds, 7 seconds, 8 seconds, 9 seconds, 10 seconds, 11 seconds, 12 seconds, 13 seconds, 14 seconds, 15 seconds, 16 seconds, 17 seconds, 18 seconds or 20 seconds, or any range of values therebetween.

### EXAMPLES

### Example 1

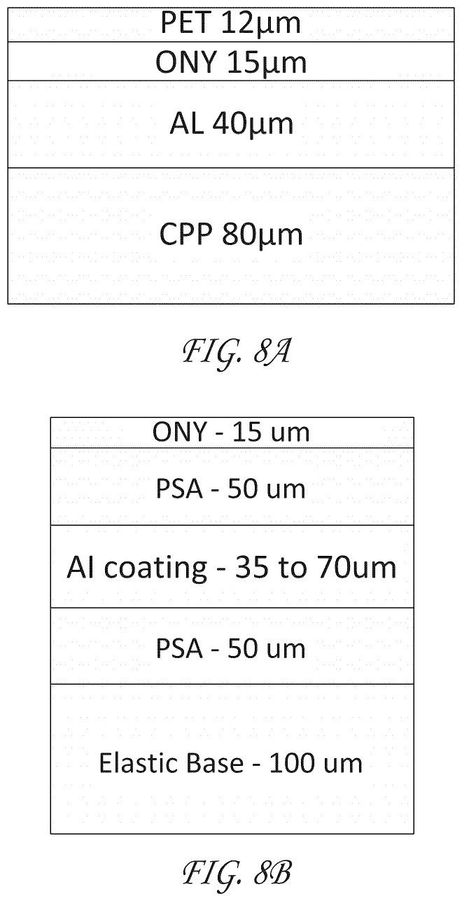

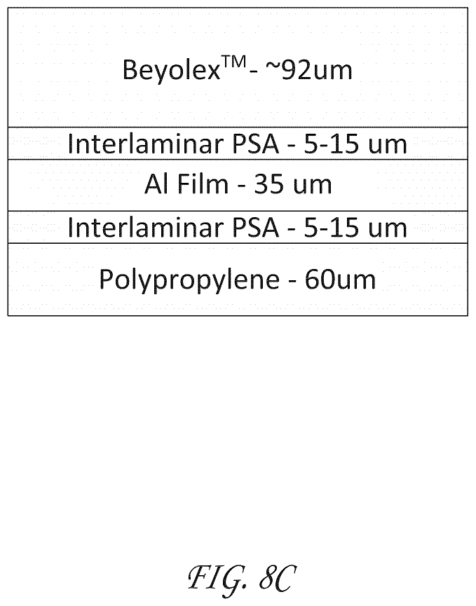

FIG. 8A is an illustration of a prepared control packaging material, and FIG. 8B is an illustration of a prepared flexible packaging material. In certain embodiments, the control packaging material includes 80 μm of a CPP layer, disposed below 40 μm of an Al foil layer, disposed below 15 μm of an ONY layer, and disposed below 12 μm of a PET layer. In certain embodiments, the flexible packaging material includes 100 μm of a Beyolex™ elastic base material layer, disposed below 50 μm of a PSA layer, disposed below 35-70 μm of an Al coating layer, disposed below 50 μm of a PSA layer, and disposed below 15 μm of a ONY layer.

Two of each of the control packaging material and the flexible packaging materials depicted in FIGS. 8A and 8B were sealed together similar to the process as depicted in FIG. 7 to form a package encapsulating a graphite anode, an NMC cathode, a separator and an electrolyte comprising LiPF₆ in EC:EMC, thereby forming a control battery and a flexible test battery. Although the packaging of the flexible test battery is thicker than the control battery, the flexible test battery was found to more easily bend, avoid crinkles when unbent, and have a softer feel.

### Example 2

FIG. 8C is an illustration of a prepared flexible packaging material. The flexible packaging material includes about 92 μm of a Beyolex™ elastic base material layer, disposed on 5-15 μm of PSA as a first interlaminar adhesive layer, disposed on 35 μm of an Al film, disposed on 5-15 μm of PSA as a second interlaminar adhesive layer, and disposed on 60 μm of a PP sealant material layer.

### Example 3

An “Aluminum Mylar” control battery is manufactured by the same process described with regard to the control battery in Example 1. A flexible “Beyolex” test battery is also prepared similar to the process for preparing the flexible test battery as described in Example 1, except the flexible packaging materials used to form the energy storage device each included a Beyolex elastic material mid-layer with a top aluminum foil layer and bottom nylon sealant layer.

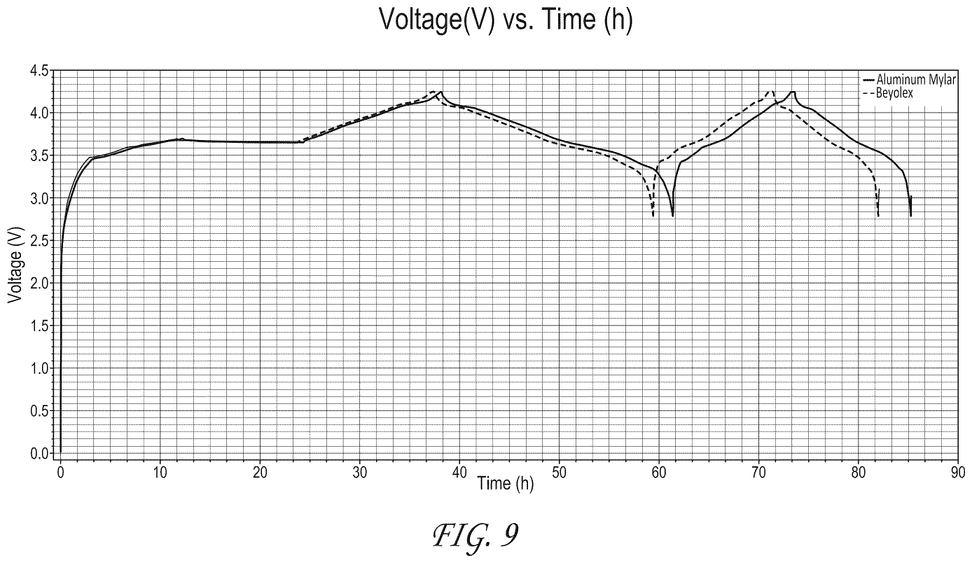

FIG. 9 shows a voltage v. time graph depicting the charge/discharge results of the “Aluminum Mylar” control battery compared to the flexible “Beyolex” test battery. Each battery cell was tap charged until 3.7 V, rested for 12 hours, with charge-discharge cycling performed at C/20 and C/10. As depicted in FIG. 9 the flexible “Beyolex” test battery and the “Aluminum Mylar” control battery demonstrated comparable charge and discharge performances.

While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount, depending on the desired function or desired result.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

The headings provided herein, if any, are for convenience only and do not necessarily affect the scope or meaning of the devices and methods disclosed herein.

1. A flexible packaging material, comprising:
an elastic material layer;
a metal foil layer; and
a sealant material layer;
wherein the metal foil layer is disposed between the elastic material layer and the sealant material layer.

2. The flexible packaging material of claim 1, wherein the elastic material layer comprises a material selected from the group consisting of a thermoplastic material, a thermoset material, and combinations thereof.

3. The flexible packaging material of claim 1, wherein the elastic material layer comprises a polymer selected from the group consisting of a styrene polymer, an isoprene polymer, an ethylene polymer, a propylene polymer, a butadiene polymer, a butylene polymer, a diene polymer, a polyurethane polymer, an acetate polymer, copolymers thereof, and mixtures thereof.

4. The flexible packaging material of claim 1, wherein the elastic material layer comprises a thickness of about 50-100 μm.

5. The flexible packaging material of claim 1, wherein the metal foil layer comprises Al.

6. The flexible packaging material of claim 1, wherein the metal foil layer comprises a thickness of about 20-60 μm.

7. The flexible packaging material of claim 1, wherein the sealant material layer comprises a material selected from the group consisting of nylon (ONY), a polypropylene (PP) resin, an ethylene and acrylic acid (EAA) a copolymer resin, copolymers thereof, orientations thereof, and mixtures thereof.

8. The flexible packaging material of claim 1, wherein the sealant material layer comprises a thickness of about 30-100 μm.

9. The flexible packaging material of claim 1, further comprising at least one interlaminar adhesive layer.

10. The flexible packaging material of claim 9, wherein a position of the at least one interlaminar adhesive layer is selected from the group consisting of disposed between the elastic material layer and the metal foil layer, disposed between the metal foil layer and the sealant material layer, and combinations thereof.

11. The flexible packaging material of claim 9, wherein the at least one interlaminar adhesive layer comprises a material selected from the group consisting of a urethane adhesive, an acrylic adhesive, a polyolefin adhesive, and combinations thereof.

12. The flexible packaging material of claim 1, the at least one interlaminar adhesive layer comprises a thickness of about 5-15 μm.

13. A flexible energy storage device, comprising:
the flexible packaging material of claim 1;
a cathode;
an anode; and
a separator disposed between the another and the cathode.

14. (canceled)

15. The flexible energy storage device of claim 13, wherein at least one of the cathode and the anode comprises an electron beam cured polymer binder.

16. A method of forming a flexible energy storage device, comprising:
disposing an energy storage device assembly between a top packaging material and a bottom packaging material, wherein the top and bottom packaging materials each comprise the flexible packaging material of claim 1; and
sealing the top and bottom packaging materials to form a sealed packaging, wherein the energy storage device assembly and the sealed packaging form a flexible energy storage device.

17. The method of claim 16, wherein sealing comprises a sealing temperature of about 130-210° C.

18. The method of claim 16, wherein sealing comprises a sealing pressure of about 25-60 psi.

19. (canceled)

20. A method of forming a flexible packaging material, comprising:
disposing a metal foil layer over an elastic material layer; and
disposing a sealant material layer over the metal foil layer.

21. The method of claim 20, further comprising disposing a first interlaminar adhesive layer over the elastic material layer, and disposing the metal foil layer over the first interlaminar adhesive layer.

22. The method of claim 20, further comprising disposing a second interlaminar adhesive layer over the metal foil layer, and disposing the sealant material layer over the second interlaminar adhesive layer.
